(19) United States
(12) Patent Application Publication
(10) Pub. No.: US 2024/0429576 A1
(43) Pub. Date: Dec. 26, 2024

(54) INTERNAL FUSE FOR BATTERY CELL

(71) Applicant: FCA US LLC, Auburn Hills, MI (US)

(72) Inventors: Wenpeng Zhao, Shanghai (CN); Zhongjun Lu, Shanghai (CN); Haiping Wu, Shanghai (CN)

(21) Appl. No.: 18/340,333

(22) Filed: Jun. 23, 2023

(51) Int. Cl. H01M 50/583; H01M 50/209; H01M 50/486; H01M 50/51

(52) U.S. Cl. CPC H01M 50/583; H01M 50/209; H01M 50/486; H01M 50/51

(57) ABSTRACT

A battery module for an electrified vehicle includes a first battery cell having a housing, a cathode, a positive end lead, an anode, a negative end lead, an isolator and a fuse. The cathode and anode can be disposed in the housing. The positive end lead can be arranged on the housing and electrically connected to the cathode. The negative end lead can be arranged on the housing. The isolator can be disposed between the housing and the negative end lead. The isolator can inhibit voltage from passing between the housing and the anode. The fuse can be electrically connected between the anode and the negative end lead and be configured to fail as a result of a short circuit condition. Voltage is inhibited from passing between the housing and the anode in a short circuit condition due to the failed fuse and the isolator.

### FIELD

The present application generally relates to electrified vehicles and, more particularly, to a battery cell incorporating an internal fuse positioned between a negative end lead of the battery cell and an anode electrode.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

A battery cell generally comprises two electrodes including an anode (negative electrode) and a cathode (positive electrode). In some conventional arrangements, a battery cell can include an integrated fuse provided between the cathode and the cell housing. The integrated fuse is designed to provide protection to the cell in the event of a short circuit condition. In some instances, however, where a short circuit condition occurs, a high voltage can be still be transmitted between the cell housing to the anode, regardless of the presence of a cathode side fuse. Such short circuit condition can cause damage to the cell and/or the module containing multiple cells. Accordingly, while such fuse configurations can provide some protection against cell damage, there exists an opportunity for improvement in the relevant art.

### SUMMARY

According to one example aspect of the invention, a battery module for an electrified vehicle includes a first battery cell having a housing, a cathode, a positive end lead, an anode, a negative end lead, an isolator and a fuse. The cathode can be disposed in the housing. The positive end lead can be arranged on the housing and electrically connected to the cathode. The anode can be disposed in the housing. The negative end lead can be arranged on the housing. The isolator can be disposed between the housing and the negative end lead. The isolator can inhibit voltage from passing between the housing and the anode. The fuse can be electrically connected between the anode and the negative end lead. The fuse can be configured to fail as a result of a short circuit condition in the battery module. Voltage can be inhibited from passing between the housing and the anode in a short circuit condition due to the failed fuse and the isolator.

In some implementations, a first electrical connection can be formed between the fuse and the negative end lead. A second electrical connection can be formed between the fuse and the anode. The first connection can comprise a first welding. The second connection can comprise a second welding.

According to another example aspect of the invention, the fuse can be formed of aluminum. The negative end lead can be formed of aluminum. The first welding can be an aluminum to aluminum weld. In examples, the isolator can be formed of elastomeric material.

In some implementations, the anode can be formed of copper. The second welding can be an aluminum to copper weld. The second welding can be a friction weld.

In other examples, the isolator can isolate the negative end lead from the housing. The battery module can further include a plurality of battery cells electrically connected in series. A polyester film can be disposed within the housing. The polyester film can be made from stretched polyethylene terephthalate (PET).

A battery module for an electrified vehicle constructed in accordance to examples of the present disclosure can include a first battery cell. The first battery cell can include a housing, a cathode, a positive end lead, an anode, a negative end lead, an isolator, an aluminum fuse and a weld. The cathode can be disposed in the housing. The cathode can be formed of aluminum. The positive end lead can be arranged on the housing and be electrically connected to the cathode. The positive end lead can be formed of aluminum. The anode can be disposed in the housing. The anode can be formed of copper. The negative end lead can be arranged on the housing. The negative end lead can be formed of aluminum. The isolator can be disposed between the housing and the negative end lead. The isolator can inhibit voltage from passing between the housing and the negative end lead. The aluminum fuse can be electrically connected between the anode and the negative end lead. The weld can be formed between the aluminum fuse and the copper anode. The fuse can be configured to fail as a result of a short circuit condition in the battery module. Voltage can be inhibited from passing between the housing and the anode in a short circuit condition due to the failed fuse and the isolator.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including a battery pack assembly according to the principles of the present application;

FIG. 2 is schematic representation of a battery cell constructed in accordance to one prior art example;

FIG. 3 is schematic representation of a battery cell constructed according to the principles of the present application;

FIG. 4 is an exemplary perspective view of a battery module having a plurality of battery cells therein according to the principles of the present application; and

FIG. 5 is a schematic representation of the battery module of FIG. 4 showing a plurality of battery cells coupled in series according to principles of the present application.

### DESCRIPTION

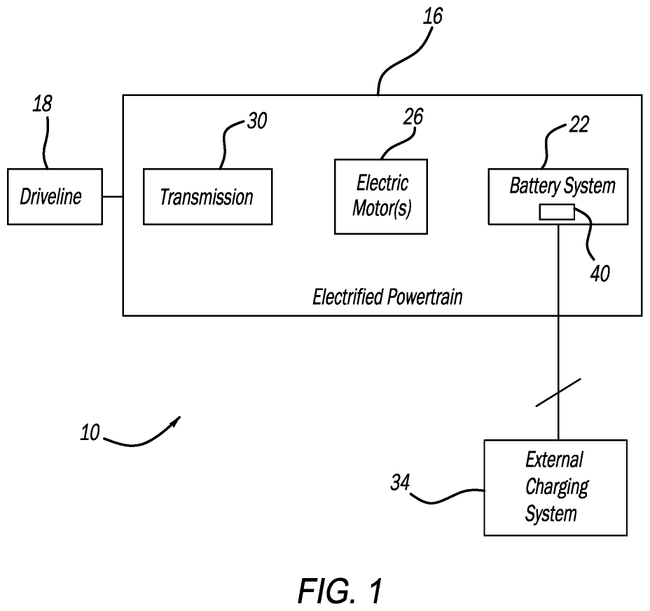

Referring to FIG. 1, a functional block diagram of an example electrified vehicle 10 (also referred to herein as “vehicle 10”) according to the principles of the present application is illustrated. The vehicle 10 includes an electrified powertrain 14 configured to generate and transfer drive torque to a driveline 18 of the vehicle 10 for propulsion. The electrified powertrain 14 generally comprises a high voltage battery system 22 (also referred to herein as “battery system 22”), one or more electric motors 26, and a transmission 30. The electric motor(s) 26 are powered by the high-voltage battery system 22 (e.g., a 16 kilowatt-hour (kWh) lithium-ion battery pack) and generate drive torque that is transferred to the driveline 18 of the vehicle 10. The battery system 22 is selectively connectable (e.g., by the driver) to an external charging system 34 (also referred to herein as “charger 34”) for charging of the battery system 22. The battery system 22 includes at least one battery pack assembly or battery module 40 having multiple battery cells therein.

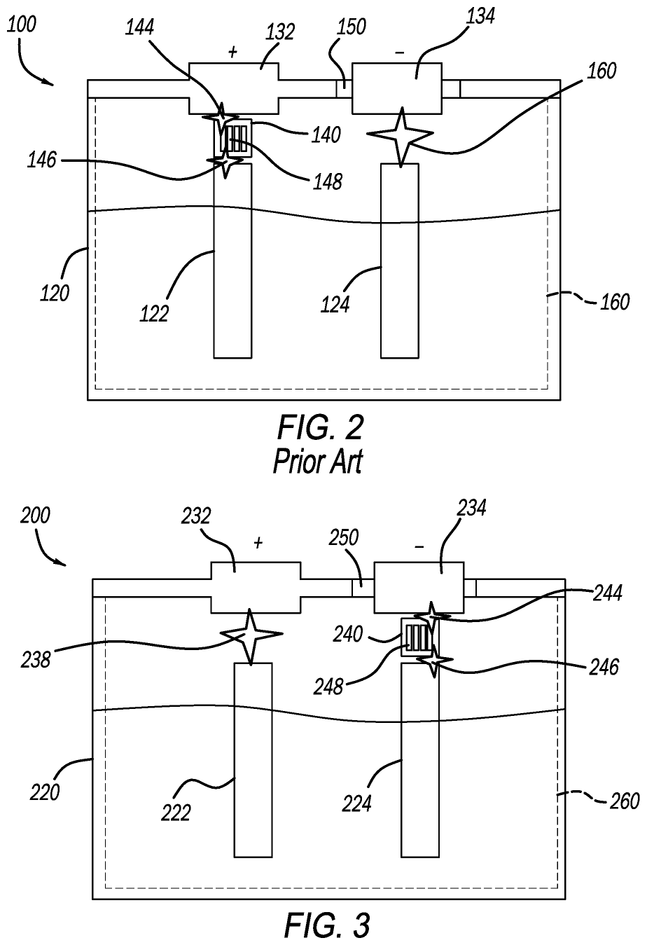

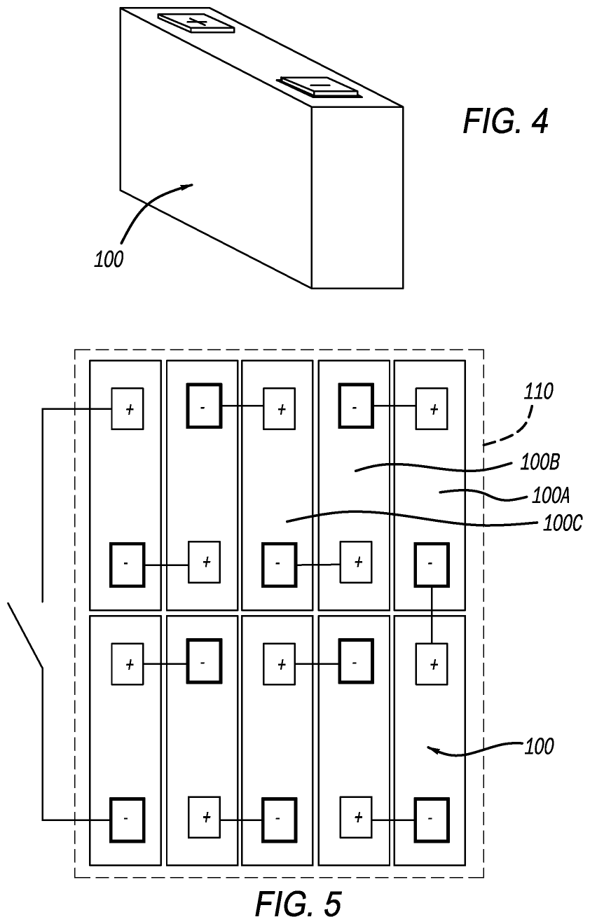

As discussed above, a battery cell generally comprises two electrodes including an anode (negative electrode) and a cathode (positive electrode). In some conventional arrangements, a battery cell can include an integrated fuse provided between the cathode and the cell housing. The integrated fuse is designed to provide protection to the cell in the event of a short circuit condition. In particular, the fuse is designed to fail or disconnect an electrical connection between the cathode and a cathode positive end lead. One such battery cell example is illustrated in FIGS. 2 and 4 and generally identified at reference numeral 100. As is known, multiple battery cells identified generally at 100 and individually at 100A, 100B, 100C, etc., can be arranged in series in a battery module 110 (FIG. 5). A typical module stack can include multiple individual battery cells 100 that are connected in series to provide a desired high voltage output based on application.

The battery cell 100 constructed in accordance to one prior art example can include a housing 120 having a cathode 122 and an anode 124. In the example shown, the cathode 122 is formed of aluminum and the anode 124 is formed of copper. A positive end lead 132 and a negative end lead 134 can be arranged on the housing 120 or otherwise be configured on the cell 100 for electrical connection therewith. A fuse 140 is provided between the cathode 122 and the positive end lead 132. In some examples, the fuse 140 can be specifically welded between the positive end lead 132 and the cathode 122. In other examples, the positive end lead 132, the fuse 140 and the cathode 122 can all be formed of aluminum where the fuse 140 can be formed by a reduction of material at first and second interface portions 144 and 146. Additionally or alternatively, holes 148 can be defined through the fuse 140.

An electrical connection 160 is formed between the anode 124 and the negative end lead 134. In examples, the electrical connection 160 can be formed by a welding. An isolator 150 can be provided between the negative end lead 134 of the anode 124. In examples, the isolator 150 can be formed of electrically non-conductive material such as rubber for example. The electrically resistant isolator 150 generally precludes or at least inhibits electrical communication therethrough.

In some instances with the prior art cell 100, where a short circuit condition occurs at the cell, the fuse 140 will burn out as designed. Even with the fuse 140 burnt out, a high voltage can be still be applied to the housing 120. In some examples, a polyester film membrane 160 can be provided inside of the housing 120. In examples, the polyester film membrane 160 can be made from stretched polyethylene terephthalate (PET).

In some cases, the voltage can break through or jump from the housing 120, through the polyester film membrane 160 and to the anode 124. It is appreciated that a distance between the housing 120 and the anode 124 is relatively small thereby allowing the voltage to be passed from the housing 120 (through the polyester film membrane 160) and to the anode 124. Such short circuit condition can cause disruption of the internal cell isolation leading to a possible thermal event and/or damage to the cell 100 or module 110.

Turning now to FIG. 3, a battery cell 200 constructed in accordance to one example of the present disclosure can include a housing 220 having a cathode 222 and an anode 224. In the example shown, the cathode 222 is formed of aluminum and the anode 224 is formed of copper. A positive end lead 232 and a negative end lead 234 can be arranged on the housing 220 or otherwise be configured on the cell 200 for electrical connection therewith.

An electrical connection 238 is formed between the cathode 222 and the positive end lead 232. In examples, the electrical connection 238 can be formed by a welding. A fuse 240 is provided between the anode 224 and the negative end lead 234. In some examples, the fuse 240 can be specifically welded at welds or first and second connection portions 244 and 246 between the negative end lead 234 and the anode 224, respectively. In some examples, the fuse 240 can be formed of aluminum. In examples, holes 248 can be formed through the fuse 240.

An electrically resistant isolator 250 can be provided between negative end lead 234 and the housing 220. In examples, the electrically resistant isolator 250 can be formed of electrically non-conductive material such as rubber for example. The electrically resistant isolator 250 can generally preclude or at least inhibit electrical communication therethrough.

In some instances with the cell 200 of the present disclosure, where a short circuit condition occurs at the cell 200, the fuse 240 will burn out as designed. With the fuse 240 burnt out, a high voltage can be still be applied to the negative end lead 234 and to the housing 220. The housing 220 is electrically connected to the positive end lead 232. In some examples, a polyester film membrane 260 can be provided inside of the housing 220. In examples, the polyester film membrane 260 can be made from stretched polyethylene terephthalate (PET). The polyester film membrane 260 can be provided inside of the housing 220.

Because the electrically resistant isolator 250 is positioned intermediate the negative end lead 234 and the housing 220 and the anode 224, the electrically resistant isolator 250 can inhibit voltage from passing from the housing 220 to the anode 224 protecting the cell 200 and the module such as during a short circuit event.

With particular reference to FIG. 3, additional features of the cell 200 will be described. The first connection portions 244 can include an aluminum to aluminum welding. In particular, the fuse 240 can be formed of aluminum consistent with the aluminum material of negative end lead 234. In examples, the first connection portion 244 can simply be a reduction in material thickness (rather than a dedicated weld) from the negative end lead 234 to the fuse 240. Additionally or alternatively, holes 248 can be defined through the fuse 240.

The second connection portion 246 can include an aluminum to copper weld. The second connection portion 246 can be formed of fusion welding or other welding technique suitable to weld dissimilar metals. In examples, a friction weld is a solid state joining process that does not require traditional melting. In this regard, a friction weld can be particularly advantageous for making an electrical connection between the copper anode 224 and the aluminum fuse 240. Other techniques or joining processes may be used.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. For example, while the battery cell 100 has been described herein specifically adapted for use in an electrified vehicle, the applications are not so limited. In this regard, the battery cell 100 can be configured for use in other applications in addition to vehicle use. Thus, variations that do not depart from the gist of the present application are intended to be within the scope of the present application.

What is claimed is:

1. A battery module for an electrified vehicle, the battery module comprising:
a first battery cell including:
a housing;
a cathode disposed in the housing;
a positive end lead arranged on the housing and electrically connected to the cathode;
an anode disposed in the housing;
a negative end lead arranged on the housing;
an isolator disposed between the housing and the negative end lead, the isolator inhibiting voltage from passing between the housing and the anode; and
a fuse electrically connected between the anode and the negative end lead, the fuse configured to fail as a result of a short circuit condition in the battery module, whereby voltage is inhibited from passing between the housing and the anode in a short circuit condition due to the failed fuse and the isolator.

2. The battery module of claim 1, further comprising:
a first electrical connection formed between the fuse and the negative end lead.

3. The battery module of claim 2, further comprising:
a second electrical connection formed between the fuse and the anode.

4. The battery module of claim 3, wherein the first connection comprises a first welding.

5. The battery module of claim 4, wherein the second connection comprises a second welding.

6. The battery module of claim 4, wherein the fuse is formed of aluminum.

7. The battery module of claim 6, wherein the negative end lead is formed of aluminum and wherein the first welding is an aluminum to aluminum weld.

8. The battery module of claim 6, wherein the anode is formed of copper and wherein the second welding is an aluminum to copper weld.

9. The battery module of claim 8, wherein the second welding is a friction weld.

10. The battery module of claim 1, wherein the isolator is formed of elastomeric material.

11. The battery module of claim 1, further comprising a plurality of battery cells electrically connected in series.

12. The battery module of claim 1, further comprising:
a polyester film membrane disposed within the housing.

13. A battery module for an electrified vehicle, the battery module comprising:
a first battery cell including:
a housing;
a cathode disposed in the housing, the cathode formed of aluminum;
a positive end lead arranged on the housing and electrically connected to the cathode, the positive end lead formed of aluminum;
an anode disposed in the housing, the anode formed of copper;
a negative end lead arranged on the housing, the negative end lead formed of aluminum;
an isolator disposed between the housing and the negative end lead the isolator inhibiting voltage from passing between the housing and the negative end lead;
an aluminum fuse electrically connected between the anode and the negative end lead; and
a weld formed between the aluminum fuse and the copper anode;
wherein the fuse is configured to fail as a result of a short circuit condition in the battery module, whereby voltage is inhibited from passing between the housing and the anode in a short circuit condition due to the failed fuse and the isolator.

14. The battery module of claim 12, wherein the weld is a friction weld.

15. The battery module of claim 13, wherein the fuse defines holes therein.

16. The battery module of claim 13, further comprising:
a polyester film membrane disposed within the housing.

17. The battery module of claim 13, further comprising a plurality of battery cells electrically connected in series.
